(19) United States
(12) Patent Application Publication
(10) Pub. No.: US 2011/0188796 A1
(43) Pub. Date: Aug. 4, 2011

(54) BEARING DEVICE

(76) Inventor: Kunihiro TSUCHIYA, Kitasaku-gun (JP)

(21) Appl. No.: 13/015,201

(22) Filed: Jan. 27, 2011

(30) Foreign Application Priority Data
Jan. 29, 2010 (JP) 2010-017659

(51) Int. Cl. F16C 33/76

(52) U.S. Cl. 384/607

(57) ABSTRACT

A bearing device has a shaft having a flange, a ball bearing rotatably supporting the shaft, a sleeve in which a ball bearing is fixed at an inside thereof, and an annular sealing member held between the flange and an inner ring of the ball bearing and forming a labyrinth seal in a gap between the annular sealing member and the sleeve.

### RELATED APPLICATIONS

This application claims priority under 35 U.S.C. §119 to Japanese Patent Application No. 2010-017659 filed on Jan. 29, 2010, the entire content of which is hereby incorporated by reference.

### BACKGROUND OF THE INVENTION

1. Field of the Invention

The present invention relates to a bearing device having a ball bearing in which leakage of lubricant charged and sealed therein can be avoided.

2. Description of the Related Art

For example, some kinds of bearing devices for supporting a magnetic head of a magnetic disc device are composed of a ball bearing in which leakage of lubricant charged and sealed therein can be avoided to reduce damage to the magnetic disc. Arts relating to the above art are described below.

Japanese Patent Application, First Publication No. 11-166526 discloses a bearing device in which a sealing plate is provided axially outside of a ball bearing and a slight gap less than 200 micrometers is provided between the sealing plate and a housing in a structure for reducing scattering and leakage of a lubricant.

Japanese Patent Application, First Publication No. 2001-84716 discloses a bearing device in which a sealing plate is provided axially outside of a ball bearing via a gap therebetween. Japanese Patent Application, First Publication No. 2008-69920 discloses a bearing unit in which a labyrinth seal composed of a gap of 0.05 mm or less is provided in a gap between an outer circumferential surface of a flange formed at one end of a shaft and an inner circumferential surface of a housing and a gap between an outer circumferential surface of a washer-shaped sealing cap fixed to the outer circumferential surface of an another end of the shaft and the inner circumferential surface of the housing.

Japanese Patent Application, First Publication No. 11-122860 discloses a spindle motor in which a rotor hub is closely fitted around a spindle which stands on a base via a pair of bearing devices. In the structure, plural labyrinth seals are provided to the bearing device at an upper end thereof. The labyrinth seals are composed of slight gaps between an outer circumferential surface of a sealing plate and the inner circumferential surface of a rotor hub or a slight gap and between the inner circumferential surface of the sealing plates and the outer circumferential surface of the spindle by fixing the plural sealing plates to the outer circumferential surface of the spindle or the inner circumferential surface of a rotor hub.

### SUMMARY OF THE INVENTION

Recently, according to improvements in memory density of magnetic disc devices, a bearing device for a pivot assembly in which leakage of a lubricant therefrom can be avoided and which can be inexpensively produced is highly desired. With respect to the above requirement, Japanese Patent Applications, First Publication No. 11-166526 and First Publication No. 2001-84716 disclose bearing devices for pivot assemblies which are assembled at low cost and have a labyrinth seal composed of annular members mounted to a straight shaft. In the above bearing devices of the pivot assemblies disclosed by Japanese Patent Applications, First Publication No. 11-166526 and First Publication No. 2001-84716, the outer diameter of a bar material processed to the shafts may be small and the materials cost can be reduced. However, the annular members mounted to the shaft may be removed and fall toward the base. Furthermore, stability is not sufficient when the bearing device of the pivot assembly is mounted to the base. Moreover, according to Japanese Patent Applications, First Publication No. 2001-84716, since the ball bearing is an open-type, the sealing function thereof is not sufficient.

In the bearing device for a pivot assembly disclosed by Japanese Patent Application, First Publication No. 2008-69920, the flange having a large outer diameter is formed on the shaft, whereby stability thereof is sufficient when the bearing device for the pivot assembly is mounted to the base. However, since the outer diameter of a bar material processed to the shaft is large and the portion to be machined therefrom in processing is also large, working cost and material cost are high.

In view of the above background, an object of the present invention is to provide a bearing device for a pivot assembly, in which an annular member mounted to a shaft will not remove and fall toward a base by using a flange as a stopper, and in particular, material cost can be reduced.

According to a first aspect of the present invention, a bearing device includes a shaft having a flange, a ball bearing rotatably supporting the shaft, a sleeve in which the ball bearing is fixed at an inside thereof, and an annular sealing member held between the flange and an inner ring of the ball bearing and forming a labyrinth seal in a gap between the annular sealing member and the sleeve.

According to the first aspect of the present invention, the ball bearing is held by the flange and a lubricant charged into the ball bearing is prevented from leaking out by the annular member held between the flange and the inner ring of the ball bearing. As a result, leaking-prevention capability same as that of a bearing device provided with a conventional flange can be maintained. In the structure according to the first aspect of the present invention, the flange does not form the labyrinth seal directly, so that the outer diameter thereof can be reduced.

According to a second aspect of the present invention, an outer circumferential surface of the flange in the first aspect slightly protrudes from an outer circumferential surface of the inner ring of the ball bearing.

According to a third aspect of the present invention, in the first aspect or the second aspect, an outer portion of the annular sealing member is bent, and the labyrinth seal is formed between the bended portion and the sleeve.

According to the first aspect of the present invention, it is possible to provide a bearing device in which the annular member mounted to the shaft thereof is prevented from removing and falling toward the base by the flange as a stopper and production cost thereof can be reduced.

According to the second aspect of the present invention, the diameter of the flange can be reduced without impairing the function thereof.

According to the third aspect of the present invention, the function of the labyrinth seal can be further improved.

### BRIEF DESCRIPTION OF THE DRAWINGS

FIG. 1A is a cross-sectional view and FIG. 1B is a partially enlarged cross-sectional view of a bearing device in accordance with a first embodiment of the present invention.

FIGS. 2A to 2D are cross-sectional views of structures showing assembling steps of the bearing device in accordance with the first embodiment of the present invention.

FIG. 3A and FIG. 3B are cross-sectional views of ball bearings in accordance with the first embodiment of the present invention.

FIG. 4A is a cross-sectional view and FIG. 4B is a partially enlarged cross-sectional view of a bearing device in accordance with a variation of the embodiment of the present invention.

FIG. 5A is a cross-sectional view and FIG. 5B is a partially enlarged cross-sectional view of a bearing device in accordance with a variation of the embodiment of the present invention.

FIG. 6A is a cross-sectional view and FIG. 6B is a partially enlarged cross-sectional view of a bearing device in accordance with a variation of the embodiment of the present invention.

### DETAILED DESCRIPTION OF THE PREFERRED EMBODIMENTS

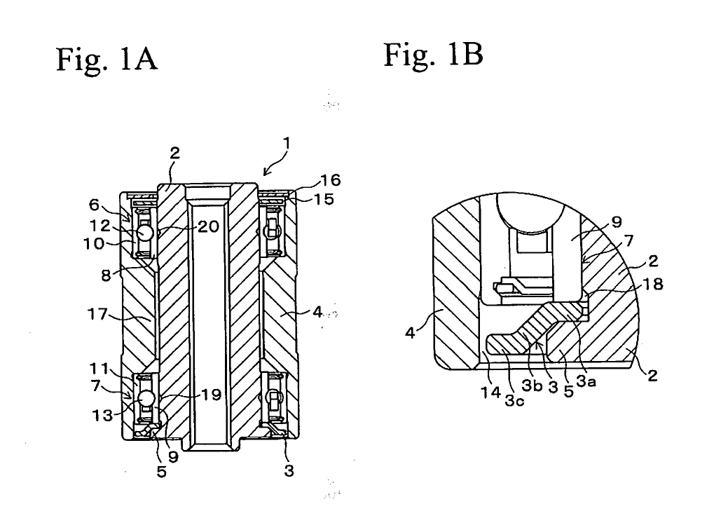

FIG. 1A and FIG. 1B show a bearing device 1 for a pivot assembly in accordance with a first embodiment of the present invention. The bearing device 1 for the pivot assembly is used for swingably supporting a swing arm to which a magnetic head for reading and writing information in a hard disc drive is mounted. The bearing device 1 for the pivot assembly is closely fitted into a through hole of a swing arm block (E block, not shown).

The bearing device 1 for the pivot assembly is provided with a shaft 2. The shaft 2 is rotatably supported by a pair of ball bearings 6 and 7. That is, the ball bearing 6 supports a rolling element 12 between an inner ring 8 and an outer ring 10, and the ball bearing 7 supports a rolling element 13 between an inner ring 9 and an outer ring 11. Moreover, the inner rings 8 and 9 are fixed to the outer surface of the shaft 2, and the outer rings 10 and 11 are fixed to the inner surface of a sleeve 4 having a cylindrical shape. A lubricant such as grease or oil for lubricating is charged and sealed in a gap between the inner rings 8 and 9 and the outer rings 10 and 11, and around the rolling elements 12 and 13.

The shaft 2 has one end (lower end in Figs.) and another end (upper end in Figs.) and a flange 5 having a smaller outer diameter than the inner diameter of the sleeve 4 is formed at the lower end of the shaft 2 which is fixed to a base of the magnetic disk device (both not shown). The size of the outer diameter of the flange 5 may be determined so as to abut on the inner ring 9 and to provide a preload. If the outer diameter of the flange 5 is too large, the material thereof may be high cost. Therefore, the outer diameter of the flange 5 should be the same as the outer diameter of the inner ring 9, and preferably should be slightly larger than the outer diameter of the inner ring 9. A circumferential groove 18 used for holding the adhesive in excess is formed on the outer surface of the shaft 2 at the position in the vicinity of the flange 5.

A sealing plate 3 is held between the flange 5 and the inner ring 9. The sealing plate 3 has a disc-shape in which a hole is formed at the center thereof when viewed from the axial direction. The shape of the sealing plate 3 is not planar, but has a cross-sectional structure of the sealing plate 3 consisting of an inner portion 3a, a middle portion 3b, and an circumferential portion 3c when viewed from the radial direction (shown in FIG. 1B).

The inner portion 3a is held between the inner ring 9 and the flange 5 in a condition in which the inner portion 3a is radially extended and the upper surface thereof is abutted on the inner ring 9 of the ball bearing 7 and the lower surface thereof is abutted on the flange 5. The middle portion 3b is radially extended while sloping downward and connected to the inner portion 3a via a curved portion. The circumferential portion 3c is radially extended and connected to the middle portion 3b via a curved portion. A labyrinth seal 14 for preventing the lubricant from leaking is provided in a condition in which the outer surface of the circumferential portion 3c and the inner surface of the sleeve 4 are faced to each other via a slight gap (within 0.2 mm). The circumferential portion 3c is not protruded beyond the flange 5 toward the axially downward direction.

Deformation of the sealing plate 3 caused by being held between the inner ring 9 and the flange 5 is prevented because the inner portion 3a is abutted on the inner ring 9 and the flange 5 and the middle portion 3b is extended from the inner portion 3a toward the radial direction while sloping downward. Since the middle portion 3b sloping downward and extending toward the radially outside direction is not abutted on the tapered portion of the edge of the flange 5, the flange 5 and the sealing plate 3 do not interfere each other. The circumferential portion 3c is radially extended from the middle portion 3b in radial outside thereof, whereby high accuracy in shape and size of the labyrinth seal 14 can be obtained. Moreover, members externally mounted are avoided from abutting on the sealing plate 3 since the circumferential portion 3c is not axially protruded beyond the flange 5.

The sealing plate 3 is formed by press-working a metallic material having a thickness which is axially thinner than the thickness of the flange 5. The material may be freely selected, and for example, a resin can be chosen as the material instead of a metal.

A spacer portion 17 abutted by end surfaces of the outer rings 10 and 11 is formed on the inner surface of the sleeve 4 for separately locating a pair of ball bearings 6 and 7. The upper end of the inner portion of the sleeve 4 is sealed by sealing plates 15 and 16.

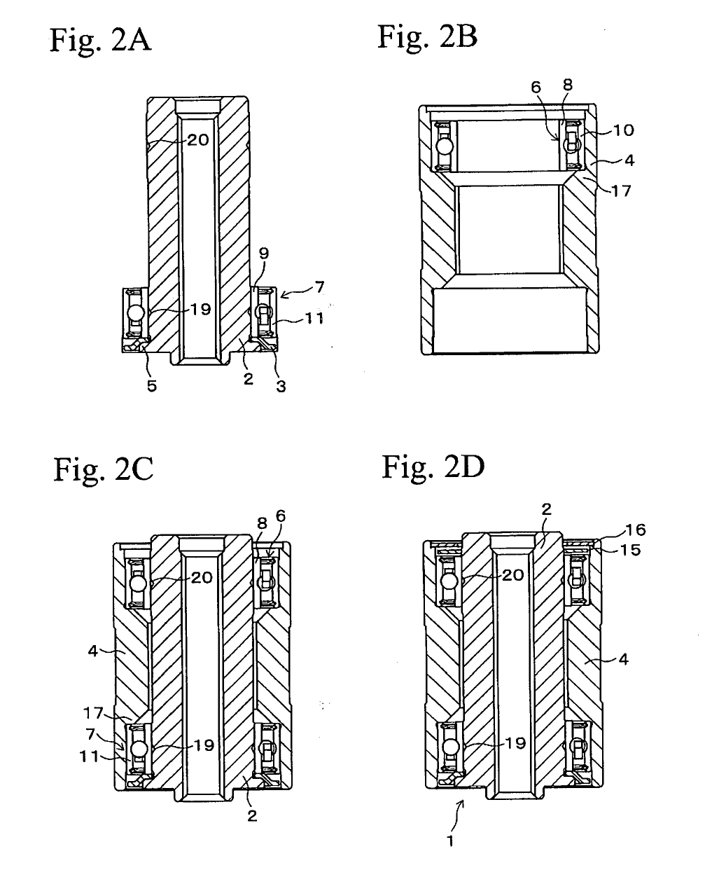

An assembly method for the bearing device 1 for the pivot assembly is explained below. In FIGS. 2A to 2D, cross-sectional structures in assembling steps of the bearing device for the pivot assembly are shown. First, the sealing plate 3 is fitted to the shaft 2 from the upper direction thereof, and is moved toward the lower direction of the shaft 2 so as to abut on the flange 5.

An anaerobic ultraviolet-curing type adhesive is applied in a V-shaped groove 19 for applying an adhesive, which was previously formed on the outer surface of the lower portion of the shaft 2. The ball bearing 7 is fitted to the shaft 2 from the upper direction with a slight clearance, whereby the lower end surface of the inner ring 9 is abutted on the sealing plate 3. In the above assembling step, the sealing plate 3 may be fixed by the inner ring 9 abutted on the sealing plate 3 and the excess of adhesive (the adhesive in the circumferential groove 18) used for fixing the inner ring 9. The adhesive is cured by irradiation of ultraviolet light so as to fix the ball bearing 7 to the shaft 2. Thus, a shaft unit (shown in FIG. 2A) is assembled.

Then, the anaerobic ultraviolet-curing type adhesive is applied on the inner surface of the upper portion of the sleeve 4, which faces the outer surface of the upper portion of the shaft 2. The ball bearing 6 is fitted to the sleeve 4 from upper direction with a slight clearance, whereby the lower end surface of outer ring 10 of the ball bearing 6 is abutted on the spacer portion 17. The adhesive is cured by irradiation of ultraviolet so as to fix the ball bearing 6 to the inner surface of the sleeve 4. Thus, a sleeve unit (shown in FIG. 2B) is assembled.

The anaerobic ultraviolet-curing type adhesive is applied in a V-shaped groove 20 for applying an adhesive, which is previously formed on an outer surface of the upper portion of the shaft 2 in the shaft unit shown in FIG. 2A and is also applied on the inner surface of the upper portion of the sleeve 4 in the sleeve unit shown in FIG. 2B. The shaft unit shown in FIG. 2A is inserted into the sleeve unit shown in FIG. 2B from the lower direction in FIGS. 2A to 2D. In the above operation, the inner ring 8 of the ball bearing 6 is fitted to the outer surface of the shaft 2 from the upper direction with a slight clearance, and the outer ring 11 of the ball bearing 7 is fitted to the inner surface of the lower portion of the sleeve 4 so as to abut on the upper end surface of the outer ring 11 at the spacer portion 17. Thus, the structure shown in FIG. 2C is assembled.

In a condition in which the lower end surface of the shaft 2 is supported, a weight (not shown) having sufficient weight for applying a predetermined preload is disposed on the upper end surface of the inner ring 8 of the ball bearing 6 which is fitted to the outer surface of the upper portion of the shaft 2 with a slight clearance. By the above operation, the ball bearings 6 and 7 are preloaded in axial direction in a condition in which the inner ring 8 is abutted on the shaft 2 and the outer ring 11 is abutted on the sleeve 4 without clearance therebetween. In the above preloaded condition, the adhesive is cured by irradiation of ultraviolet light. The weight for preload applied to the upper end surface of the inner ring 8 is predetermined as a value necessary for obtaining the required resonance frequency.

An annular sealing plate 15 is press fitted to the outer surface of the upper portion of the shaft 2, and an annular sealing plate 16 is press fitted to the inner surface of the upper portion of the sleeve 4. Thus, the bearing device for the pivot assembly 1 shown in FIG. 2D is assembled. It should be noted that the annular sealing plates 15 and 16 may be fixed by the anaerobic ultraviolet-curing type adhesive.

The result of evaluating the material cost of the bearing device 1 for the pivot assembly is explained hereinafter. In Table 1, comparisons of the costs of the materials and working of the embodiment and conventional products are shown.

TABLE 1

| | Conventional | | Reducing |
|---|---|---|---|
| | product | Embodiment | rate |
| Material cost | 100% | 54% | 46% |
| Working | 100% | 90% | 10% |
| Cost | | | |

As is clearly shown in Table 1, the material cost was reduced at a rate of 46% and working cost was reduce at rate of 10% compared to the material and working cost in the conventional product. The working cost was calculated on the basis of the comparison of working cycle-time. The sizes of the shafts of the embodiment and the conventional product used for the comparison are shown in Table 2. In the shaft of the embodiment, the outer diameter of the flange was reduced to reduce the cost.

TABLE 2

| | Outer diameter | Total length | Width of | Outer diameter |
|---|---|---|---|---|
| | of shaft | of shaft | flange | of flange |
| | (mm) | (mm) | (mm) | (mm) |
| Conventional | 6.35 | 19.00 | 1.00 | 10.00 |
| product | | | | |
| Embodiment | 6.35 | 19.00 | 1.00 | 7.30 |

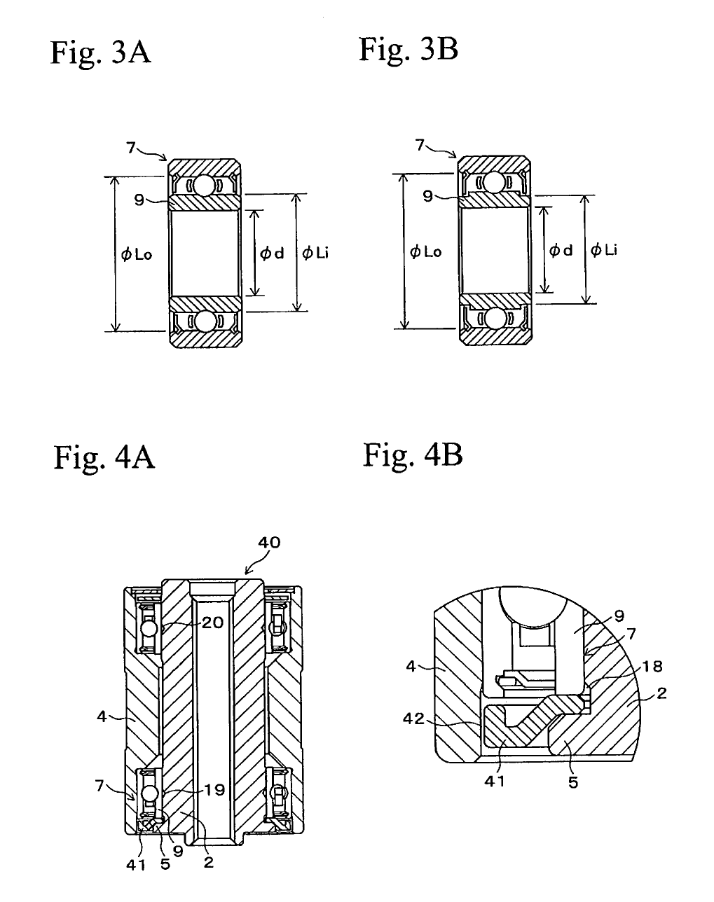

According to the present embodiment, the outer diameter of the flange 5 is set to be slightly larger than the outer diameter φLi of the inner ring 9 shown in FIG. 3A. In a case where a stepped portion is formed at the end of the inner ring 9 as shown in FIG. 3B, the smaller outer diameter is considered as the outer diameter φLi. The lower limit value f of the width of the portion of the flange 5 radially protruding from the outer surface of the shaft 2 can be calculated by the following Formula 1 in which the outer diameter φLi and the inner diameter φd of the inner ring 9 are used.

f=(φLi−φd)/2 Formula 1

According to the present embodiment, since the width of the portion of the flange 5 protruding beyond the outer surface of the shaft 2 is adjusted to be larger than the above value f, when viewed from the axial direction, the outer surface of the flange 5 is radially protruding beyond the outer surface of the inner ring 9. The ball bearing RI-6144ZZ produced by Minebea Co., Ltd., wherein φLi is 7.25 mm and φd is 6.35 mm, is used in the present embodiment. Applying the Formula 1, one gets f=[(7.25-6.35)/2]=0.45, so that the protruding width of the portion of the flange 5 protruding beyond the outer surface of the shaft 2 can be set to 0.475 mm, which is slightly larger than the value f, and the outer surface of the flange 5 protrudes 0.025 mm toward the radially outer direction from the outer surface of the inner ring 9. In the above structure in which the outer diameter of the flange 5 is slightly larger than the outer diameter of the inner ring 9, the dimension of the axially inner chamfer is larger than that of the axially outer chamfer, so that the interference between the flange 5 and the sealing plate 3 is prevented.

The radially protruding width of the portion of the flange 5 protruding beyond the outer surface of the inner ring 9 is preferably substantially the same as or slightly larger than the value f. For example, the radially protruding width of the portion of the flange 5 may be the value f added with the value equal or smaller than the chamfer dimension of the flange 5. By this design, the flange 5 can be made smaller than conventional and the manufacturing cost can be reduced. Furthermore, fixing of the sealing plate 3 and a preload for the ball bearings 6 and 7 can be ensured. As a matter of course, the radially protruding width of the flange portion may be smaller than the value f as far as these functions are not lowered.

If the outer surface of the flange 5 does not protrude beyond the outer surface of the inner ring 9, the possibility of problems such as deformation of the sealing plate 3, change of preload for the ball bearings 6 and 7 and decrease of the sealing function of the sealing plate 3 caused by deformation thereof may increase.

If the outer diameter of the flange 5 becomes much larger than the diameter φLi, the function of the flange 5 may be saturated and the material cost and working cost caused by enlargement of the outer diameter of the flange 5 may be increased.

Advantages of the bearing device 1 for the pivot assembly of the embodiment will be explained hereinafter. In the bearing device 1 for the pivot assembly, the annular members (ball bearings) mounted to the shaft 2 are prevented from removing and falling toward the base because the small diameter flange 5 works as a stopper. Relating to the above function, the assembly operation, such as positioning the members, can be easily performed by the presence of flange 5. Furthermore, a preload can be applied to the ball bearings 6 and 7 easily and with high accuracy by the presence of the flange 5.

In the bearing device 1 for the pivot assembly, the shaft 2 is mounted to the base of the magnetic disc device (not shown), and an E block of a swing arm is fixed to the sleeve 4. In this condition, axial force applied to the sleeve 4 is received by the flange 5, whereby generation of excessive clearance between the members in actual use can be inhibited.

Moreover, in the bearing device 1 for the pivot assembly, the labyrinth seal 14 composed of the minute gap (within 0.2 mm) between the outer circumferential surface of the sealing plate 3 and the inner circumferential surface of the sleeve 4 is provided. The leakage of lubricating grease or lubricating oil sealed in the ball bearings 6 and 7 from the bearing device 1 for the pivot assembly can be avoided by the labyrinth seal 14. Furthermore, dust can be prevented from entering into the bearing device 1 for the pivot assembly by the labyrinth seal 14.

In the above structure, the outer diameter of the flange 5 of the shaft 2 is smaller than that of a conventional flange having a large diameter and provided to a bearing device for a pivot assembly disclosed in Japanese Patent Application, First Publication No. 2008-69920, whereby the flange 5 only slightly protrudes from the outer surface of the shaft 2. As a result, even though the leaking of the lubricant can be avoided efficiently, the portion to be machined and the material cost can be greatly reduced compared to a conventional shaft mounted with a flange having a large diameter. It should be noted that the sealing plate 3 required in the embodiment can be inexpensively produced by press-working, whereby the effect of the sealing plate 3 with respect to the total cost of the product, is small.

Modifications of the embodiment will be explained hereinafter. FIGS. 4A, 5A and 6A are cross-sectional views and FIGS. 4B, 5B and 6B are partially enlarged cross-sectional views of the bearing device in accordance with modifications of the embodiment. Modifications of the bearing device of the first embodiment are shown in FIGS. 4A, 5A and 6A and FIGS. 4B, 5B and 6B. In FIGS. 4A to 6B, for the components with the same reference numerals as in FIG. 1, the same explanation referring to FIG. 1 can be applied.

The modifications explained hereinafter are different from the first embodiment shown in FIGS. 1A and 1B in structures of sealing plate. The structures for holding the sealing plate 3 are the same as the case shown in FIGS. 1A and 1B. In FIGS. 4A and 4B, a bearing device 40 for a pivot assembly in accordance with a modification of the embodiment is shown. In the bearing device 40 for the pivot assembly, a sealing plate 41 is held between the flange 5 and the inner ring 9 of the ball bearing 7, which is the same as the structure in FIGS. 1A and 1B. The sealing plate 41 is provided in such a way that the circumferential portion 3c of the sealing plate 3 is outwardly extended and bent toward the axially upper direction, so that a minute gap is formed between the radially outer circumferential surface of the bent portion thereof and the inner circumferential surface of the sleeve 4, whereby the length of labyrinth seal 42 is enlarged. According to this structure, sealing function for avoiding the lubricant from leaking therefrom is reliable. In this structure, since the sealing plate 41 is not protruded to the outside, the bearing device 40 for the pivot assembly can be easily mounted to an E block of a swing arm.

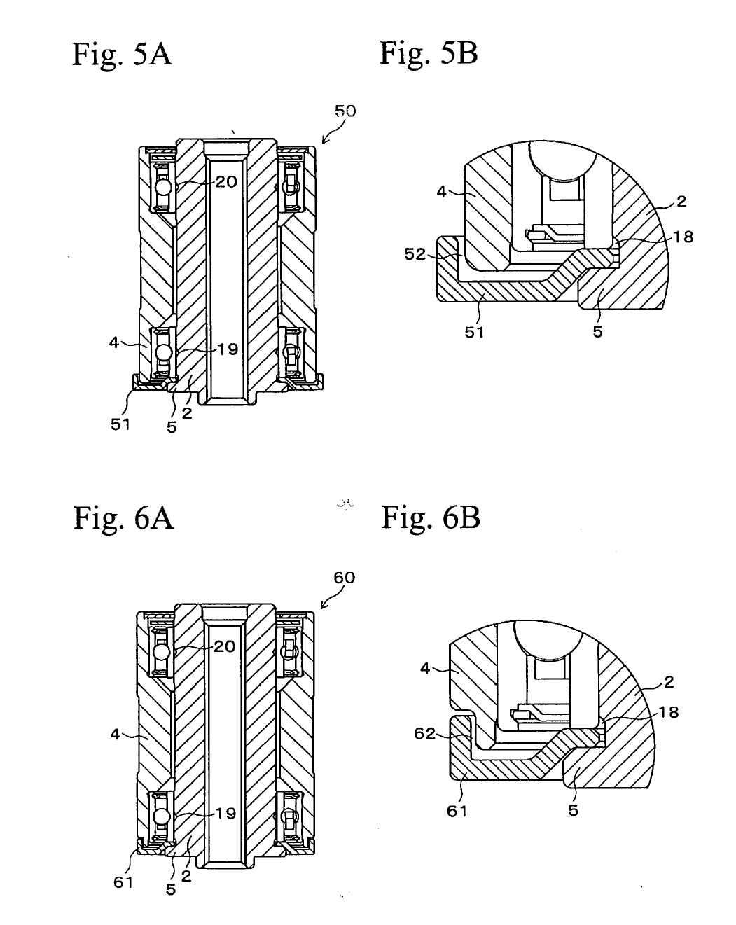

A bearing device 50 for a pivot assembly is shown in FIGS. 5A and 5B. The bearing device 50 for the pivot assembly is provided with a sealing plate 51. The sealing plate 51 is provided in such a way that an circumferential portion thereof is radially extended beyond the outer circumferential surface of the sleeve 4 and is bent toward the axially upper direction. According to this structure, a labyrinth seal 52 is formed with a minute gap between the inner circumferential surface of the bent portion 52a and the outer circumferential surface of the sleeve 4 and a minute gap between the upper end surface of the sealing plate 51 and the lower end surface of the sleeve 4, thereby enlarging the length of labyrinth seal 52. The above structure can be easily obtained because the extended portion of the circumferential portion is easily bent, and the length of labyrinth seal 52 can be enlarged compared to the structures in FIGS. 4A and 4B. Since the sealing plate 51 is protruded from the outer circumferential surface of the sleeve 4, in mounting the structure to an E block of a swing arm, a space for containing the extended portion of the sealing plate 51 is required in the structure of the E block.

A bearing device 60 for a pivot assembly is shown in FIGS. 6A and 6B. In this structure, the diameter of the lower end portion of the sleeve 4 is reduced in the vicinity of a base. The circumferential portion of the sealing plate 61 outwardly extended and axially bent toward the upper direction is contained in the reduced diameter portion at the lower end of the sleeve 4. The outer circumferential surface of the axially bent portion 62a which is bent toward the upper direction does not radially protrude from the outer circumferential surface of the sleeve 4. A labyrinth seal 62 is composed of a minute gap formed between the inner circumferential surface of the axially bent portion 62a and the outer circumferential surface of the reduced diameter portion of the sleeve 4 and a minute gap formed between the top end surface of the bent portion 62a and the surface of the stepped portion continuing from the reduced diameter portion of the sleeve 4. According to this structure, the outer diameter of the sealing plate 61 can be smaller than the maximum outer diameter of the sleeve 4. The bearing device 60 for the pivot assembly which does not have a protruding portion can be easily mounted to an E block, and the length of labyrinth seal 62 can be further enlarged compared to the structure in FIGS. 5A and 5B.

According the above structures, the circumferential portion of the sealing plate is extended and axially bent and the labyrinth seal is provided between the axially extended portion and the inner or outer surface of the sleeve 4, whereby sufficient length of the labyrinth seal can be maintained.

In the above embodiments, the present invention is explained as the bearing devices for a pivot assembly. The present invention may be applied to other bearing devices used for other uses.

The present invention can be applied to bearing devices and to other products using such bearing devices.

What is claimed is:

1. A bearing device comprising:
a shaft having a flange;
a ball bearing rotatably supporting the shaft;
a sleeve in which the ball bearing is fixed at an inside therebt and
an annular sealing member held between the flange and an inner ring of the ball bearing and forming a labyrinth seal in a gap between the annular sealing member and the sleeve.

2. The bearing device according to claim 1, wherein an outer circumferential surface of the flange has a diameter slightly larger than a diameter of an outer surface of an inner ring of the ball bearing.

3. The bearing device according to claim 1, wherein a circumferential portion of the annular sealing member is bent and the labyrinth seal is formed between the bent portion and the sleeve.

4. The bearing device according to claim 3, wherein the circumferential portion of the annular sealing member is bent toward an axial direction thereof.

5. The bearing device according to claim 4, wherein the bent circumferential portion is positioned around the outer circumferential surface of the sleeve.

6. The bearing device according to claim 4, wherein the sleeve includes a recessed portion, and the bent circumferential portion is contained within the recessed portion.
